(19) United States
(12) Patent Application Publication
(10) Pub. No.: US 2011/0222055 A1
(43) Pub. Date: Sep. 15, 2011

(54) DETERMINATION OF THE SALT CONCENTRATION OF AN AQUEOUS SOLUTION

(75) Inventors: Ivana Durickovic, Metz (FR); Mario Marchetti, Liverdun (FR); Rémy Claverie-Rospide, Pompey (FR); Jean Livet, Champenoux (FR); Patrice Bourson, Norroy-le-veneur (FR); Marc Fontana, Semecourt (FR); Jean-Marie Chassot, Paris (FR)

(73) Assignee: UNIVERSITE DE METZ PAUL VERLAINE, METZ CEDEX 01 (FR)

(21) Appl. No.: 13/124,012

(22) PCT Filed: Oct. 16, 2009
(86) PCT No.: PCT/FR09/51977

§ 371 Date: May 31, 2011

(30) Foreign Application Priority Data
Oct. 17, 2008 (FR) 0857091

(51) Int. Cl. G01J 3/44

(52) U.S. Cl. 356/301

(57) ABSTRACT

A method of determining the concentration of a salt that may be present in a substance containing at least some water, comprising the following steps: a) recording the Raman spectrum of photons scattered by the substance in the wave number range 2500 cm⁻¹ to 4000 cm⁻¹; b) determining, for a given temperature of the substance, two points of said spectrum corresponding to two specific wave numbers; c) calculating the ratio of two magnitudes representative of said points to obtain a measurement ratio; and d) comparing said measurement ratio to a reference chart representative of the concentration of the salt for various temperatures as a function of the concentration of said salt. The method advantageously requires no taking of samples and may be contactless.

This is a 371 national phase application of PCT/FR2009/051977 filed 16 Oct. 2009, claiming priority to French Patent Application No. 0857091 filed 17 Oct. 2008, the contents of which are incorporated herein by reference.

### FIELD OF THE INVENTION

The present invention provides a method of determining the salt concentration of an aqueous solution.

### BACKGROUND OF THE INVENTION

Numerous methods exist for determining the concentration of a known salt in aqueous solution, in particular chemical measurement methods using a sample of the solution.

However, there are numerous situations in which taking samples is either impossible or unacceptable economically.

This is the situation, for example, in the field of winter maintenance of road infrastructures requiring the detection of road de-icing agents and the measurement of their residual quantities on the roads in order to enable the competent services to take decisions, when appropriate, about spreading road de-icing agents again.

This problem also arises in the agri-foodstuffs industry in particular. It may be a question of quantifying the salt content of a product during or at the end of its manufacturing process.

It may equally be a question of evaluating the ageing of a product, for example, yoghurt, by tracking over time the salt content of its whey.

It may equally be a question of determining the quantity of waste salt in brine produced by manufacturing methods.

It may further be a question of determining the chlorine concentration in a swimming pool.

This problem also arises more generally in relation to environmental problems, where it is necessary to measure waste salt in aqueous solution and to evaluate the pollution of land by salt that may result therefrom.

### SUMMARY OF THE INVENTION

One object of the present invention is to provide a method of determining the salt concentration in an aqueous solution that makes this determination possible without taking samples of the solution to be checked and with or without making contact with the solution.

To achieve this object, the method of the invention for determining the concentration of a salt that may be present in a substance containing at least some water is characterized in that it comprises the following steps:

a) recording the Raman spectrum of photons scattered by the substance in the wave number range 2500 per centimeter (cm⁻¹) to 4000 cm⁻¹;

b) determining, for a given temperature of the substance, two points of said spectrum corresponding to two specific wave numbers;

c) calculating the ratio of two magnitudes representative of said points to obtain a measurement ratio; and

d) comparing said measurement ratio to a reference chart representative of the concentration of the salt for various temperatures as a function of the concentration of said salt.

The method clearly constitutes a good response to the objectives set out because in an initial stage, which may be performed in the laboratory, a reference chart is produced representative of the concentration of the salt in the aqueous solution or, more generally, in the substance at different temperatures as a function of the concentration of the salt. This preliminary step is followed by a step of measuring the real solution or, more generally, the real substance to be tested using only a recording of the Raman spectrum of the substance to be tested and digital and logical processing of that recording.

Clearly the means for implementing the method comprise only a source of photons, a Raman spectrometer, and information processing means.

As a result of this, there need be no contact between the means implementing the method and the substance that is the subject of the phase determination.

Also, as a result of this, all the means for implementing the method may be in motion relative to the substance to be checked or relative to a support on which that substance is located.

As a final result of this, the determination is undertaken regardless of conditions external to the substance.

It should be added that the expression “aqueous solution” of a salt refers to any substance containing a salt and water in highly varying percentages. There need be only trace amounts of water.

To determine said chart, the following operations are preferably performed:
the Raman spectrum of said substance is recorded for different concentrations and at different temperatures;
for each Raman spectrum, two points on the spectrum corresponding to said predetermined specific wave numbers are determined;
the ratio of two magnitudes representative of said points is calculated to obtain a reference measurement ratio; and
in the same system of axes a reference curve of said reference measurement ratios as a function of concentration is determined for each temperature.

Clearly, this reference chart may be determined in the laboratory from a sample of the aqueous solution to be tested.

The concentration determination method is preferably characterized in that said curves of the reference chart are mathematical regression curves representative of values of the reference measurement ratios for the same temperature.

The concentration determination method is preferably characterized in that one of the two specific wave numbers is chosen in a sub-range of wave numbers in which the Raman spectrum is representative of the salt entering into the composition of said substance or in which the Raman spectrum varies relative to that of water because of said salt, and the other specific wave number is chosen in another sub-range of wave numbers in which the Raman spectrum is representative of water in general.

Other objects of the invention consist in the application of the method defined above to detecting the quantity of salt in aqueous solutions, or more generally in substances, in different situations, notably, for detecting road de-icing agents and measuring the residual quantity thereof on the road;

for determining the salt concentration of an agri-foodstuffs industry product; and

for detecting waste salt in aqueous solution in effluents.

### BRIEF DESCRIPTION OF THE DRAWINGS

Other features and advantages of the invention become more apparent on reading the following description of several preferred embodiments of the invention given as non-limiting examples. The description refers to the appended figures, in which:

FIG. 1 shows a typical Raman spectrum for a salt in aqueous solution;

FIG. 2 shows an example of determining the reference curve of salt concentration as a function of Raman intensity for a given temperature;

FIG. 3 shows an example of a chart giving the salt concentration in an aqueous solution for different temperatures;

FIG. 4 shows equipment for implementing the method of the invention to determine the concentration of de-icing agents on a road;

FIG. 4A shows the essential elements of information processing means used in the equipment shown in FIG. 4; and

FIG. 5 shows examples of Raman spectra SA, SB, and SC for solutions of sodium chloride, potassium acetate, and urea, respectively.

### DETAILED DESCRIPTION

As explained above, the method of the invention uses Raman spectrometry.

This technique is well known in itself and thus has no need to be described in detail.

It suffices to outline its general principle.

When a transparent sample is subjected to a monochromatic electromagnetic wave, a small fraction of the light is scattered.

Frequency analysis of the scattered light shows up a component of the same wavelength as the incident light (elastic scattering) and a component comprising wavelengths different from the incident beam (inelastic scattering).

It is this second component that is used in Raman spectroscopy. The Raman spectrum of the scattered beam is characteristic of the material to which the electromagnetic beam was applied.

The method of determining the salt concentration of an identified aqueous solution is described below.

The method of the invention includes a preliminary step of constructing a reference curve chart followed by a step of determining the real salt concentration of the aqueous solution to be studied.

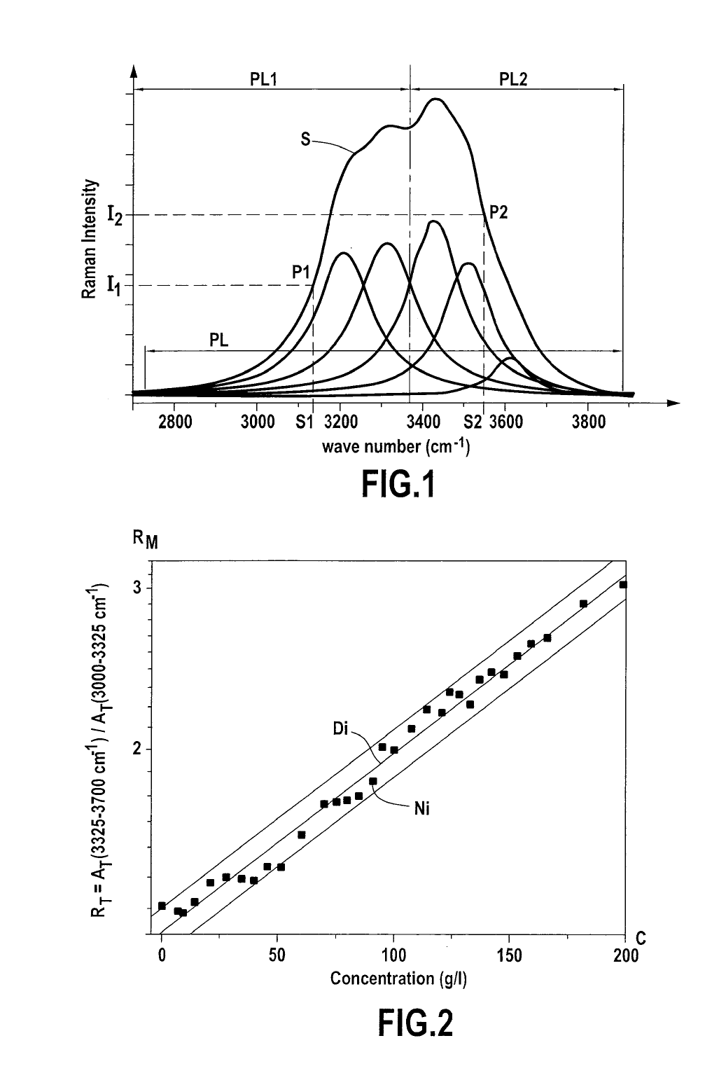

FIG. 1 shows a Raman spectrum S for the solution in which the salt concentration is to be determined, this Raman spectrum corresponding to a given temperature and a given salt concentration.

In this figure, wave numbers are plotted along the abscissa axis and Raman intensities up the ordinate axis.

The total range PL of wave numbers may be divided into two sub-ranges PL₁ and PL₂ respectively corresponding to an area representative of the element entering into the composition of the solution or in which the Raman spectrum varies relative to that of water because of said element, and an area representative of water in general outside any area of influence of the above-mentioned element. An appropriate choice of the two specific wave numbers S1 and S2 situated in the respective sub-ranges makes it possible to improve the sensitivity of the method of obtaining the reference chart. For example, for the wave number representative of the element entering into the composition, a characteristic peak appearing in the Raman spectrum could be chosen.

To each of the wave numbers S1 and S2 there naturally corresponds a point P1 or P2 on the curve S. Each point P1 and P2 is associated with a magnitude representative of its Raman intensity. This may be the intensities I₁ and I₂ themselves, or it may be the areas A₁ and A₂ between the curve S and the abscissa axis for limited curve portions around the points P1 and P2. A measurement ratio Rₘ between these representative magnitudes is then calculated.

$${R}_{m} = \frac{{I}_{1} ( {S}_{1} , T , C )}{{I}_{2} ( {S}_{2} , T , C )} ;$$

$${R}_{m} = \frac{{A}_{1} ( {S}_{1} , T , C )}{{A}_{2} ( {S}_{2} , T , C )}$$

This produces a measurement ratio Rₘ corresponding to a given salt concentration and a given temperature. The Raman spectrum is then determined from a sample corresponding to a different concentration at the same temperature T. From these different measurements, the different points Nᵢ corresponding to the same temperature T for different salt concentrations may be plotted on a graph. For example, in the appended FIG. 2, the measurement points Ni correspond to a solution of sodium chloride at a fixed temperature. The different measurement points Ni are fitted, for example, as a linear fit on a logarithmic scale, for example, by mathematical regression, to associate this set of measurements with a representative curve Di.

It nevertheless goes without saying that for other salts these curves need not be straight line portions.

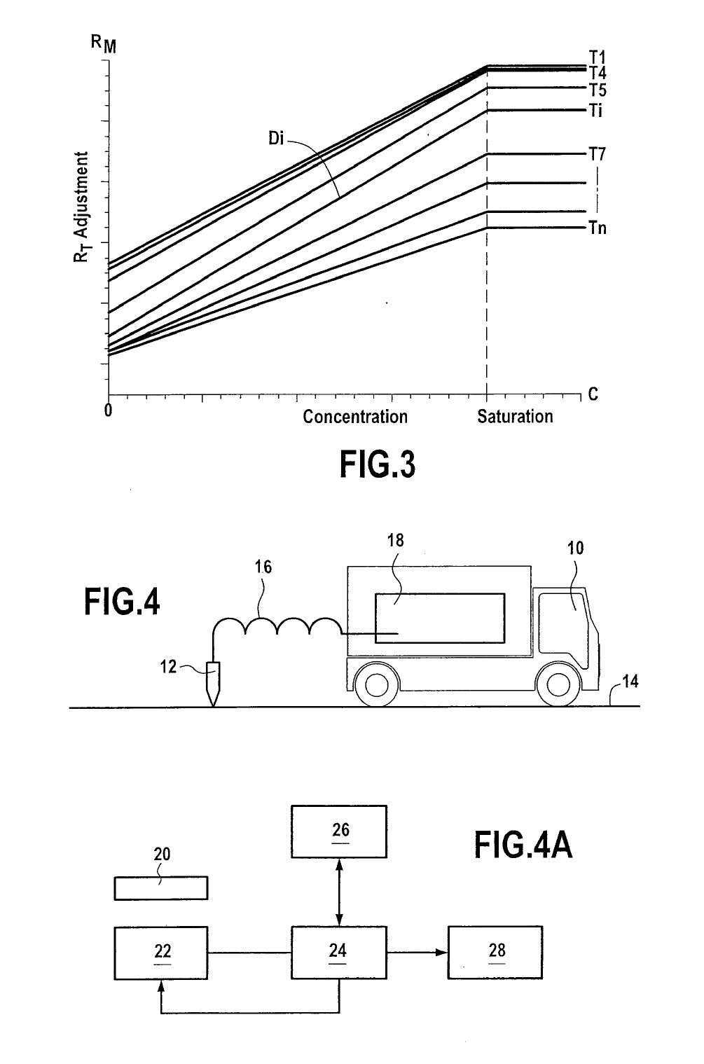

This operation is repeated for different temperatures in the range of temperatures concerned. The different straight lines Di that give the measurement ratio Rₘ plotted up the ordinate axis as a function of the concentration C plotted along the abscissa axis for different temperatures Ti may then be plotted on the same graph. Thus, curves are obtained for the temperatures T1 to Tn as shown in FIG. 3.

The chart shown in FIG. 3 consists of the curves giving the relationships between the measurement ratio Rₘ and the concentration, and it constitutes the reference chart used in the method of the invention.

Once the reference chart has been obtained for the aqueous solution to be checked, it is possible to determine the concentration of any aqueous solution of this type by the method of the invention by carrying out the following steps.

The Raman spectrum for the aqueous solution to be tested and the temperature of the solution are determined. Points P1 and P2 corresponding to the specific wave numbers S1 and S2 are determined from the Raman spectrum S corresponding to the aqueous solution concerned, which is of the type represented in FIG. 1. For each of the points P1 and P2 the measurement ratio Rₘ corresponding to the particular example of aqueous solution to be tested is determined using either the intensities themselves or the areas. A pair of values is obtained in this way consisting of the measurement ratio Rₘ and the temperature T.

The salt concentration of the aqueous solution may then be determined using the reference chart shown in FIG. 3. The curve Di corresponding to the measured temperature is of course chosen, and then the point on that curve Di is chosen that corresponds to the determined measurement ratio, thereby obtaining the concentration of the aqueous solution.

Different uses of the above-described method are described below. A first use consists in equipment for determining the phase of an aqueous solution of road de-icing substances (for example, NaCl) spread over a road.

As shown in FIG. 4, the equipment comprises a vehicle 10 having a Raman probe 12 mounted on its outside and directed toward the road 14 on which the aqueous solution to be tested has been spread. The probe 12 is connected by optical fibers 16, for example, to an onboard installation 18 in the vehicle.

The installation may comprise a laser source 20 and a Raman spectroscope 22 connected to the optical fibers 16. The spectroscope 22 sends information to a processor unit 24, which information corresponds to the successively established Raman spectrum S. The information capture instants may be generated automatically by the processor unit 24.

The processor unit 24 is associated with a memory 26 for storing data relating to the reference chart, the wave numbers S1 and S2, and software for processing the received Raman spectra.

For each received spectrum, a measurement ratio Rₘ is calculated and the calculated measurement ratio Rₘ is compared to the reference chart to deduce the concentration of the aqueous solution. A display screen 28 enables the operator to view the results. These results may equally constitute control data for a device or method and thus feed into the control loop of the device or method.

Of course, uses of the method may be envisaged other than those referred to above. It suffices that they rely on determining the concentration of a salt in a substance, in particular, an aqueous solution, provided it contains a sufficient quantity of water to enable use of the method.

The salt could of course be different depending on the application concerned. Thus, the salt could be chosen from the group comprising chlorides, acetates, formates, urea, or a combination of said salts.

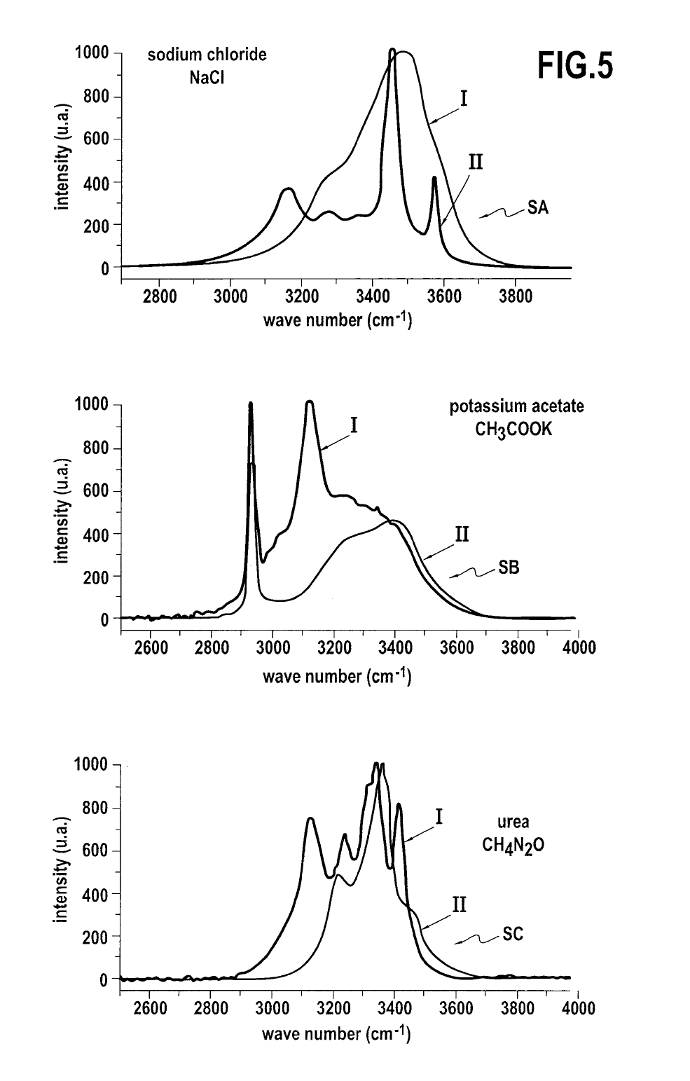

To illustrate the different fields of application of the method, FIG. 5 shows three Raman spectra SA, SB, and SC corresponding to sodium chloride, potassium acetate, and urea, respectively.

For each salt, there are shown the curve I for the liquid state and the curve II for the solid state. These Raman curves show clearly that for each salt it is possible to choose two specific wave numbers that make it possible to obtain very accurate concentration measurements.

1. A method of determining the concentration of a salt that may be present in a substance containing at least some water, said method comprising the following steps:
a) recording the Raman spectrum of photons scattered by the substance in the wave number range 2500 cm⁻¹ to 4000 cm⁻¹;
b) determining, for a given temperature of the substance, two points of said spectrum corresponding to two specific wave numbers;
c) calculating the ratio of two magnitudes representative of said points to obtain a measurement ratio; and
d) determining the concentration of the salt based on said measurement ratio by using a reference chart representative of the relationship between said measurement ratio and the concentration of the salt for various temperatures.

2. A concentration determination method according to claim 1, wherein, in order to determine said chart:
the Raman spectrum of said substance is recorded for different concentrations and at different temperatures;
for each Raman spectrum two points on the spectrum corresponding to said predetermined specific wave numbers are determined;
the ratio of two magnitudes representative of said points is calculated to obtain a reference measurement ratio; and
in the same system of axes, a reference curve of said reference measurement ratios as a function of concentration is determined for each temperature.

3. A concentration determination method according to claim 2, wherein said curves of the reference chart are mathematical regression curves representative of values of the reference measurement ratios for the same temperature.

4. A concentration determination method according to claim 1, wherein one of the two specific wave numbers is chosen in a sub-range of wave numbers in which the Raman spectrum is representative of the salt entering into the composition of said substance or in which the Raman spectrum varies relative to that of water because of said salt, and the other specific wave number is chosen in another sub-range of wave numbers in which the Raman spectrum is representative of water in general.

5. A concentration determination method according to claim 1, wherein said representative magnitudes are the intensities of the Raman spectrum for the two specific wave numbers.

6. A concentration determination method according to claim 1, wherein said specific magnitudes are areas defined by the Raman spectrum in the vicinity of said points.

7. A concentration determination method according to claim 1, wherein the salt is chosen in the group comprising chlorides, acetates, formates, urea, or a combination of said salts.

8. An application of the method according to claim 1 to detecting road de-icing agents and to measuring their residual quantity on the road.

9. An application of the method according to claim 1 to determining the salt concentration of an agri-foodstuffs industry product.

10. An application of the method according to claim 1 to detecting waste salt in aqueous solution in effluent.
